(19) United States
(12) Patent Application Publication
(10) Pub. No.: US 2009/0280321 A1
(43) Pub. Date: Nov. 12, 2009

(54) Edge Banding

(76) Inventor: Harry V. EMPTING, JR., Lake City, TN (US)

Correspondence Address: PITTS AND BRITTIAN P C, P O BOX 51295, KNOXVILLE, TN, 37950-1295, US

(21) Appl. No.: 12/437,148

(22) Filed: May 7, 2009

Related U.S. Application Data
(60) Provisional application No. 61/051,449, filed on May 8, 2008.

(51) Int. Cl. B32B 27/08; B32B 27/30; B32B 27/32; B29C 47/06

(52) U.S. Cl. 428/339; 428/517; 428/516; 264/173.16

(57) ABSTRACT

Edge banding comprises an outer layer comprising a thermoplastic selected from the group consisting of polypropylene, acrylonitrile butadiene styrene and polyvinyl chloride and an under layer comprising ethylene vinyl acetate. The outer layer and the under layer are thermally bonded by co-extrusion. The prior need for a primer is eliminated. Delamination caused by improper application of primer is eliminated.

### CROSS-REFERENCE TO RELATED APPLICATIONS

Applicant claims the benefit of Provisional application Ser. No. 61/051,449, filed May 8, 2008.

### STATEMENT REGARDING FEDERALLY SPONSORED RESEARCH OR DEVELOPMENT

Not Applicable

### BACKGROUND OF THE INVENTION

1. Field of Invention

This invention pertains to flexible edge banding

More particularly, this invention pertains to an improved edge banding comprising a co-extrusion of ethylene vinyl acetate with a thermoplastic selected from the group consisting of polyvinyl chloride (PVC), acrylonitrile butadiene styrene (ABS) and polypropylene (PP).

2. Description of the Related Art

Edge banding is used as a protective and decorative covering for the edge of composite board or plywood, which has a decorative top surface, such as Formica, for example. This type of construction is very often used in the production of office furniture. Both the edge banding and the laminate are generally secured to the board with an adhesive. Edge banding is often adhered to the board with an adhesive comprising EVA mixed with a filler.

In the past, edge banding has commonly been formed from PVC. PVC has good abrasion resistance and trims easily. However, PVC does not adhere well unless the edge banding is coated with a primer. Improper application of primer leads to delamination of the edge banding. More importantly, PVC is dangerous to the environment because, if burned, it decomposes to release chlorine gas, a dangerous chemical.

Polypropylene is a thermoplastic random copolymer which is generally environmentally “friendly.” However, polypropylene does not adhere well to EVA adhesives, even when a primer is applied to the edge band.

### BRIEF SUMMARY OF THE INVENTION

According to one embodiment of the present invention, edge banding comprises a co-extrusion of an exposed layer of polypropylene and an under layer of EVA is provided.

In another embodiment edge banding comprises a co-extrusion of an exposed layer of ABS and an under layer of EVA is provided.

In a further embodiment, edge banding comprises a co-extrusion of an exposed layer of PVC and an under layer of EVA is provided.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a cross-sectional elevation view of an edge banding in accordance with the present invention.

FIG. 2 is an exploded plan view of a die for co-extruding two thermoplastic materials.

FIG. 3 is an elevation view of a co-extruder.

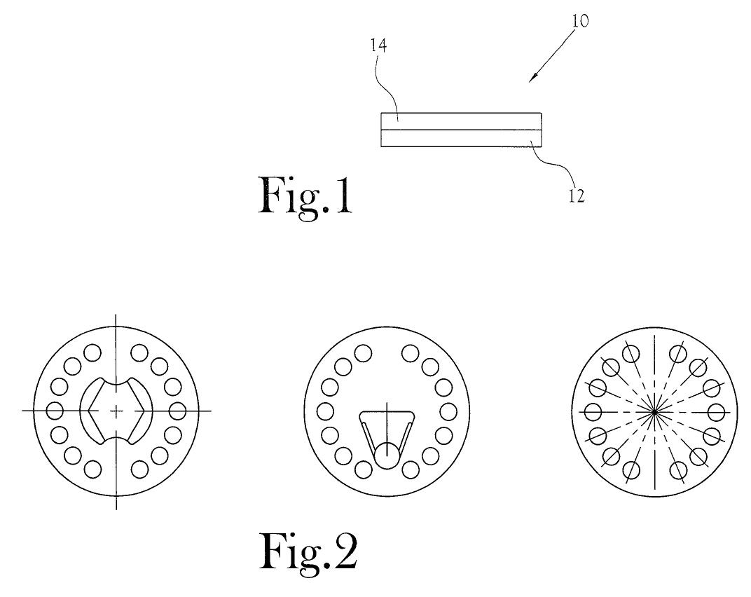

### DETAILED DESCRIPTION OF THE INVENTION

An edge banding comprising an exposed outer layer of a thermoplastic selected from the group consisting of PP, ABS and PVC is coextruded with an under layer of EVA thermally bonded to the exposed outer layer is disclosed.

FIG. 1 illustrates a simplified schematic of one embodiment of edge banding 10 in accordance with the present invention. The edge banding 10 comprises an exposed outer layer 12, which is decorative and abrasion resistant, and an under layer 14 adapted for adhesive attachment to an edge of a board.

In one embodiment, the under layer 14 is about 8 mils in thickness and comprises 18% EVA, a blend of 18% vinyl acetate and 82% polyethylene. One source of suitable EVA is sold by Lyondell Chemical Company under the name ULTRATHENE® UE624000.

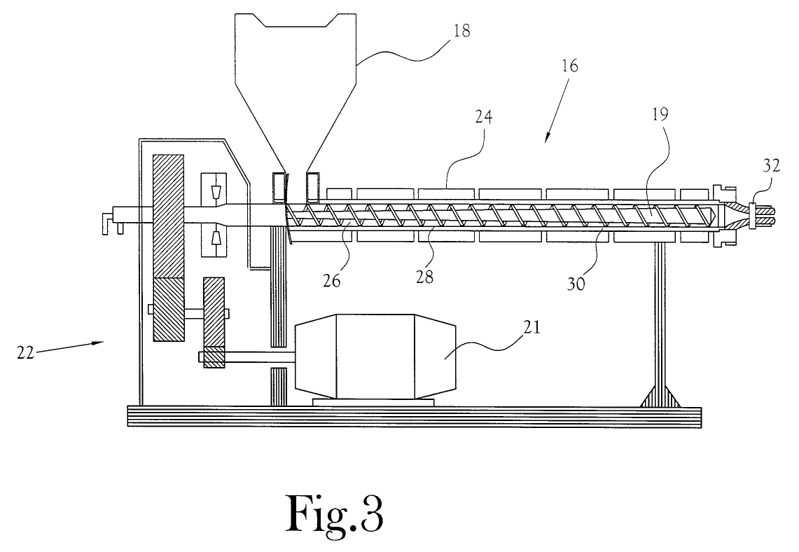

The outer layer 12 is about 0.02 to 1.2 mils in thickness and comprises polypropylene. A suitable source for polypropylene is sold by Formosa Plastic Company under the name FORMOLENE® 7320B. The two layers 12 and 14 are co-extruded through an extruder as illustrated in FIG. 3, at a temperature of about 340 to 420° F. and preferably at a temperature of about 400 to 420° F. to form a thermal bond between the two layers 12 and 14.

Polypropylene does not trim as easily as PVC. Accordingly, when trimming is an issue for the finished product, about 15% low density polyethylene may be added to the polypropylene in the outer layer 12.

As discussed hereinabove, the outer exposed layer 12 may comprise ABS or PVC in similar dimensions. A suitable ABS is sold by the Formosa Chemicals & Fibre Corp under the name TAIRILAC® AG10AP.

The under layer 14 comprising EVA provides a secure attachment of the edge banding to a board using an EVA based adhesive because there is a thermal bond between the two layers 12 and 14 and a molecular bond between the EVA of the under layer 14 and the EVA adhesive. The prior need for a primer is eliminated. Delamination caused by improper application of primer is eliminated.

FIG. 3 discloses an apparatus 16 for co-extruding two thermoplastics. Thermoplastic pellets are fed through a hopper 18 into a barrel containing a screw 19. The screw 19 is rotated by a motor 21 through a gearing system 22. The screw 19 is surrounded by a plurality of heaters 24 for melting the thermoplastic pellets. The screw 19 advances the heated thermoplastic pellets through a feed zone 26, then a compression zone 28 and then a metering zone 30 before entering the die 32.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. comprising:
an outer layer comprising a thermoplastic selected from the group consisting of polypropylene, acrylonitrile butadiene styrene and polyvinyl chloride;
an under layer comprising ethylene vinyl acetate;
said outer layer and said under layer being thermally bonded by co-extrusion.

2. The edge banding of claim 1 wherein said under layer has a thickness of about 8 mils.

3. The edge banding of claim 1 wherein outer layer comprises polypropylene.

4. The edge banding of claim 1 wherein said outer layer comprises a blend of polypropylene and low density polyethylene.

5. The edge banding of claim 1 wherein said outer layer and said under layer are thermally bonded at a temperature of between about 340 to 420° F.

6. The edge banding of claim 1 wherein said outer layer and said under layer are thermally bonded at a temperature of between about 400 to 420° F.
